(19) United States
(12) Patent Application Publication
(10) Pub. No.: US 2014/0354533 A1
(43) Pub. Date: Dec. 4, 2014

(54) TAGGING USING EYE GAZE DETECTION

(71) Applicant: Shivkumar Swaminathan, Woodinville, WA (US)

(72) Inventor: Shivkumar Swaminathan, Woodinville, WA (US)

(21) Appl. No.: 13/908,889

(22) Filed: Jun. 3, 2013

(51) Int. Cl. G06F 3/01

(52) U.S. Cl. CPC G06F 3/017
USPC 345/156

(57) ABSTRACT

Various embodiments relating to tagging human subjects in images are provided. In one embodiment, an image including a human subject is presented on a display screen. A dwell location of a tagging user's gaze on the display screen is received. The human subject in the image is recognized as being located at the dwell location. An identification of the human subject is received, and the image is tagged with the identification.

### BACKGROUND

Face tagging, i.e., matching names with faces in images, provides a way to search for people in images that are stored on computers or mobile devices. In one example, face tagging is performed with a mouse and keyboard. In particular, the mouse is used to select a face region of a person of interest in an image, and the keyboard is used to type the name of that person to create an associated tag. However, the process of face tagging numerous images that each may have multiple faces may be a labor and time intensive task, because each face has to be selected using the mouse and a name has to be typed each time a face is selected.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments relating to tagging human subjects in images are provided. In one embodiment, an image including a human subject is presented on a display screen. A dwell location of a tagging user's gaze on the display screen is received. The human subject in the image is recognized as being located at the dwell location. An identification of the human subject is received, and the image is tagged with the identification.

### BRIEF DESCRIPTION OF THE DRAWINGS

FIG. 1 shows a computing system according to an embodiment of the present disclosure.

FIG. 2 schematically shows a computer architecture block diagram according to an embodiment of the present disclosure.

FIG. 3 shows an example of visual feedback indicating that a human subject is recognized at a dwell location of a tagging user's gaze.

FIG. 4 shows another example of visual feedback indicating that a human subject is recognized at a dwell location of a tagging user's gaze.

FIG. 5 shows yet another example of visual feedback indicating that a human subject is recognized at a dwell location of a tagging user's gaze.

FIG. 6 schematically shows a tagging interface for tagging a human subject in an image.

FIG. 7 schematically shows a tagging interface for tagging a recognized human subject in different images.

FIG. 8 show a method for tagging a human subject in an image presented on a display screen according to an embodiment of the present disclosure.

FIG. 9 shows a method for establishing a dwell location of a tagging user's gaze according to an embodiment of the present disclosure.

FIG. 10 shows a method for recognizing identification of a human subject according to an embodiment of the present disclosure.

FIG. 11 shows another method for recognizing identification of a human subject according to an embodiment of the present disclosure.

FIG. 12 schematically shows a computing system according to an embodiment of the present disclosure.

### DETAILED DESCRIPTION

The present disclosure relates to tagging images with metadata, such as identification of human subjects depicted in images. More particularly, the present disclosure relates to tagging human subjects in images using eye gaze tracking based selection. In one example, the present disclosure provides mechanisms that enable receiving a dwell location of a tagging user's gaze on an image presented on a display screen, recognizing that a human subject in the image is located at the dwell location, receiving an identification of the human subject, and tagging the image with the identification. Typically, humans are attuned to recognizing patterns, such as faces of other humans. Accordingly, a user may select a human subject in an image by looking at the human subject quite faster than selecting the human subject in the image with a mouse or touch input.

Furthermore, in some embodiments, the present disclosure provides mechanisms to receive a name of the human subject recognized in the image from a voice recognition system that listens for the name being spoken by the tagging user. The recognized name may be mapped to the image to tag the human subject. By using voice recognition to tag a name of a recognized human subject to an image, a tagging user may avoid having to type the name on a keyboard. Accordingly, a large volume of images may be tagged in a timelier and less labor intensive manner relative to a tagging approach that uses a mouse and keyboard.

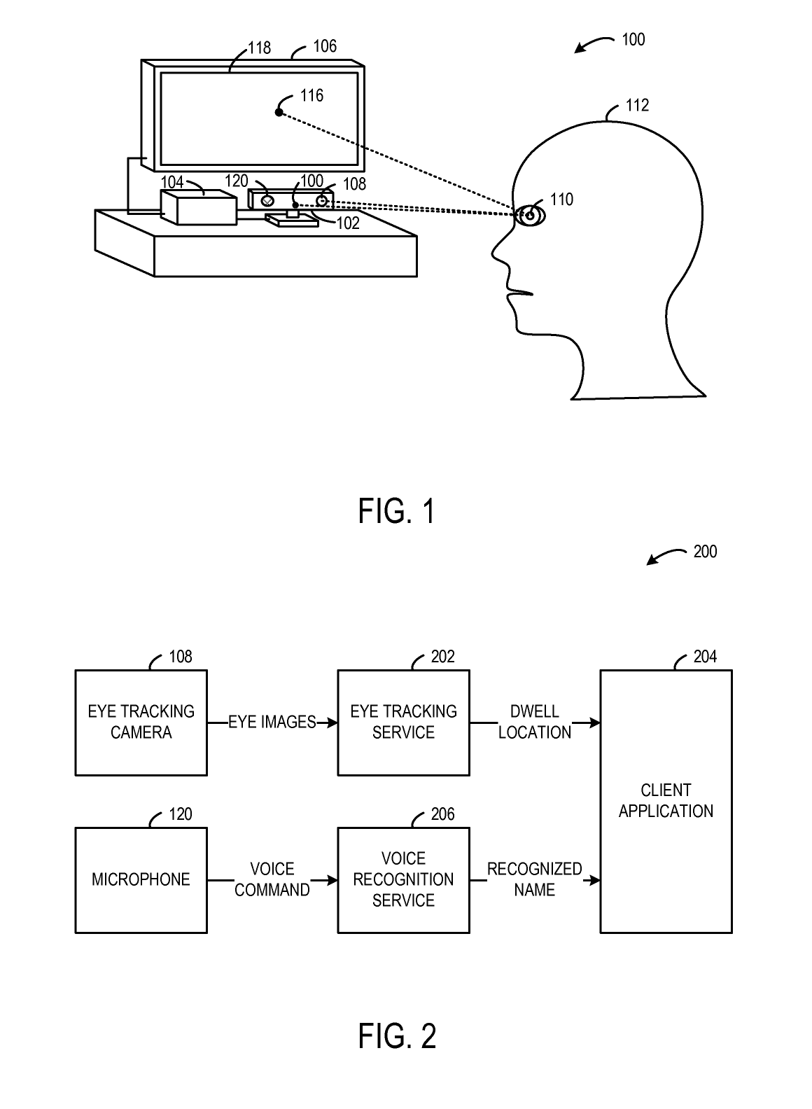

FIG. 1 shows a computing system 100 according to an embodiment of the present disclosure. The computing system 100 may include a user input device 102, a computing device 104, and a display device 106.

The user input device 102 may include an eye tracking camera 108 configured to detect a direction of gaze or location of focus of one or more eyes 110 of a user 112 (e.g., a tagging user). The eye tracking camera 108 may be configured to determine a user's gaze in any suitable manner. For example, in the depicted embodiment, the user input device 102 may include one or more glint sources 114, such as infrared light sources, configured to cause a glint of light to reflect from each eye 110 of the user 112. The eye tracking camera 108 may be configured to capture an image of each eye 110 of the user 112 including the glint. Changes in the glints from the user's eyes as determined from image data gathered via the eye tracking camera may be used to determine a direction of gaze. Further, a location 116 at which gaze lines projected from the user's eyes intersect a display screen 118 of the display device 106 may be used to determine an object at which the user is gazing (e.g., a displayed object at a particular location).

Furthermore, the user input device 102 may include a microphone 120 (or other suitable audio detection device) configured to detect the user's voice. More particularly, the microphone 120 may be configured to detect the user's speech, such as a voice command. It is to be understood that the microphone may detect the user's speech in any suitable manner.

The user input device 102 may be employed to enable the user 112 to interact with the computing system 100 via gestures of the eye, as well as via verbal commands. It is to be understood that the eye tracking camera 108 and the microphone 120 are shown for the purpose of example and are not intended to be limiting in any manner, as any other suitable sensors and/or combination of sensors may be utilized.

The computing device 104 may be in communication with the user input device 102 and the display device 106. The computing device 104 may be configured to receive and interpret inputs from the sensors of the user input device 102. For example, the computing device 104 may be configured to track the user's gaze on the display screen 118 of the display device 106 based on eye images received from the eye tracking camera 108. More particularly, the computing device 104 may be configured to detect user selection of one or more objects displayed on the display screen (e.g., a human subject in an image) based on establishing a dwell location. The computing device 104 may be configured to process voice commands received from the user input device 102 to recognize a particular word or phrase (e.g., a name of a selected human subject). The computing device 104 may be configured to perform actions or commands on selected objects based on the processed information received from the user input device (e.g., tagging a human subject in an image with a name).

It will be appreciated that the depicted devices in the computing system are described for the purpose of example, and thus are not meant to be limiting. Further, the physical configuration of the computing system and its various sensors and subcomponents may take a variety of different forms without departing from the scope of the present disclosure. For example, the user input device, the computing device, and the display device may be integrated into a single device, such as a mobile computing device.

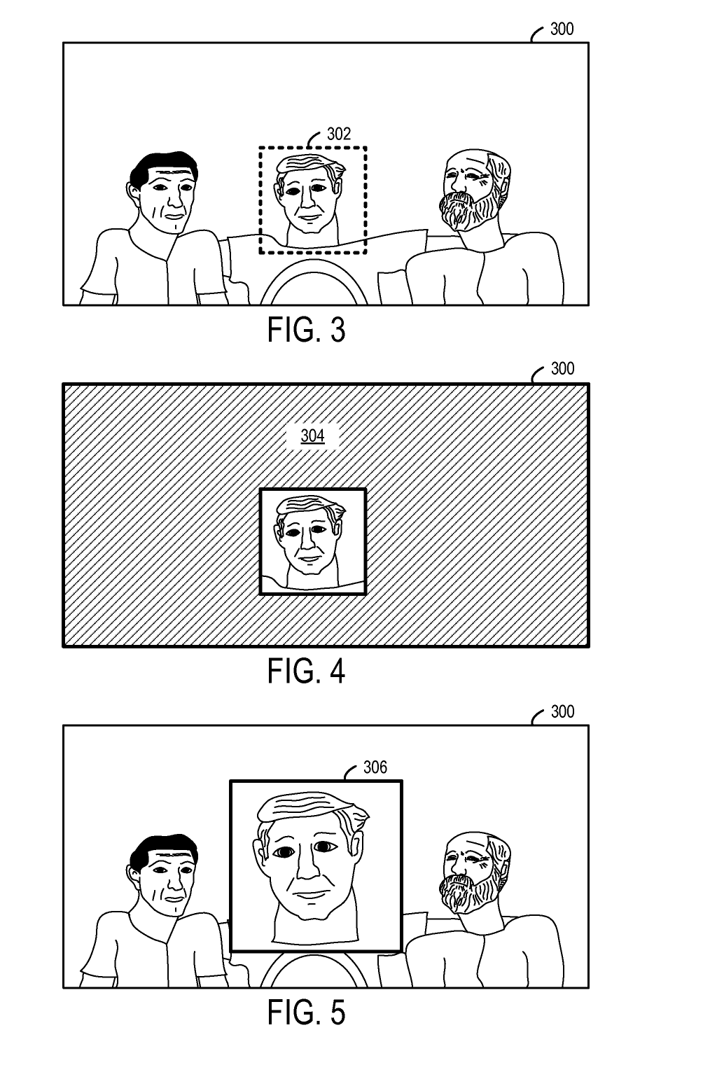

FIG. 2 schematically shows a block diagram of a computer architecture 200 according to an embodiment of the present disclosure. The computer architecture 200 may enable tagging of a human subject in an image presented on a display screen using gaze detection of a tagging user to select the human subject, and voice recognition to recognize a name of the selected human subject to be tagged. For example, the computer architecture may be implemented in the computing system 100 of FIG. 1.

In one example, the eye tracking camera 108 may provide eye images of the tagging user's eyes to an eye tracking service 202. The eye tracking service 202 may be configured to interpret the eye images to determine the tagging user's eye gaze on a display screen. More particularly, the eye tracking service 202 may be configured to determine whether the tagging user's gaze is focused on a location of the display screen for greater than a threshold duration (e.g., 100 microseconds). If the user's gaze is focused on the location for greater than the threshold duration, then the eye tracking service 202 may be configured to generate a dwell location signal that is sent to a client application 204.

The client application 204 may be configured to receive the dwell location signal from the eye tracking service 202. The dwell location signal may include display screen coordinates of the dwell location. The client application 204 may be configured to determine whether a human subject in an image presented on the display screen is located at the dwell location. If a human subject is recognized as being located at the dwell location, the client application 204 may be configured to provide visual feedback to the tagging user that the human subject is recognized or selected. For example, the client application 204 may be configured to display a user interface on the display screen that facilitates provision or selection of a name to tag the image of the human subject. For example, the client application 204 may be configured to prompt a user to provide a name for the human subject and command a voice recognition service 206 to listen for a name being spoken by the tagging user via the microphone 120.

It is to be understood that the client application 204 may be any suitable application that is configured to associate metadata with an image (i.e., tagging). In one example, the client application may be a photograph editing application. As another example, the client application may be a social networking application.

The microphone 120 may be configured to detect a voice command from the tagging user, and send the voice command to the voice recognition service 206 for processing. The voice recognition service 206 may be configured to recognize a name from the voice command, and send the name as identification of the human subject to the client application 204. The client application 204 may be configured to tag the image with the identification.

In some embodiments, identification for tagging of the human subject may be provided without voice recognition. For example, identification may be provided merely through gaze detection. In one example, the client application 204 may be configured to display a set of previously recognized names on the display screen responsive to a human subject being recognized as being positioned at a dwell location. The client application 204 may be configured to receive a different dwell location of the tagging user's gaze on the display screen, recognize that a name from the set of previously recognized names is located at the different dwell location, and select the name as the identification of the human subject in the image.

It is to be understood that the set of previously recognized names may be populated in any suitable manner. For example, the set of previously recognized names may be populated by previous tagging operations, social networking relationships of the tagging user, closest guesses based on facial recognition, etc.

In some embodiments, the client application 204 may be configured to determine whether the name received from the voice recognition service 206 (or via another user input) has been previously recognized by comparing the name to the set of previously recognized names. If the name has not been previously recognized, then the client application 204 may be configured to add the name to the set of previously recognized names. For example, the set of previously recognized names may be used to speed up name recognition processing by the voice recognition service, among other operations. In one example, mapping of names to human subjects may be made more accurate by having a smaller list of possible choices (e.g., the set of previously recognized names).

In some embodiments, the client application 204 may be configured to display different images that potentially include the recognized human subject on the display screen in order to perform additional tagging operations. For example, the client application 204 may be configured to identify a facial pattern of the recognized human subject, run a facial pattern recognition algorithm on a plurality of images to search for the facial pattern of the recognized human subject, and display different images that potentially include the facial pattern of the recognized human subject on the display screen. Furthermore, the client application 204 may be configured to prompt the tagging user to confirm whether a human subject in a different image is the recognized human subject. If a confirmation that the recognized human subject is in the different image is received (e.g., via a vocal confirmation from the tagging user detected by the microphone 120 or a gaze dwelling on a confirmation button for a threshold duration), then the client application 204 may be configured to tag the different image with the name of the human subject. The client application 204 may be configured to repeat the process for all images that potentially include the recognized human subject. In this way, the plurality of images may be tagged in a quicker and less labor intensive manner than a tagging approach that uses a mouse and keyboard.

It is to be understood that, in some embodiments, the eye tracking service 202 and the voice recognition service 206 may be implemented as background services that may be continuously operating to provide the dwell location and recognized name to a plurality of different client applications (e.g., via one or more application programming interfaces (APIs)). In some embodiments, the eye tracking service 202 and the voice recognition service 206 may be incorporated into the client application 204.

FIGS. 3-5 show various examples of visual feedback that may be provided to a tagging user to indicate that a human subject in an image is recognized as being positioned at a dwell location of the tagging user's gaze. For example, the visual feedback may be provided in a graphical user interface that may be generated by the client application 204 shown in FIG. 2.

FIG. 3 shows an image 300 including three human subjects. The middle human subject is recognized as being positioned at a dwell location by visual feedback 302 in the form a box surrounding a head of the human subject. The box highlights the selection of the middle human subject by the tagging user's gaze.

FIG. 4 shows the same image 300 as shown in FIG. 3. However, in this example, the visual feedback 304 includes graying out the image surrounding the head of the human subject that is recognized as being positioned at the dwell location.

FIG. 5 shows the same image 300 as shown in FIG. 3. However, in this example, the visual feedback 306 includes enlarging the head of the human subject that is recognized as being positioned at the dwell location relative to the remainder of the image. It is to be understood that any suitable visual feedback may be provided to a tagging user to indicate selection of a human subject in an image based on the tagging user's gaze.

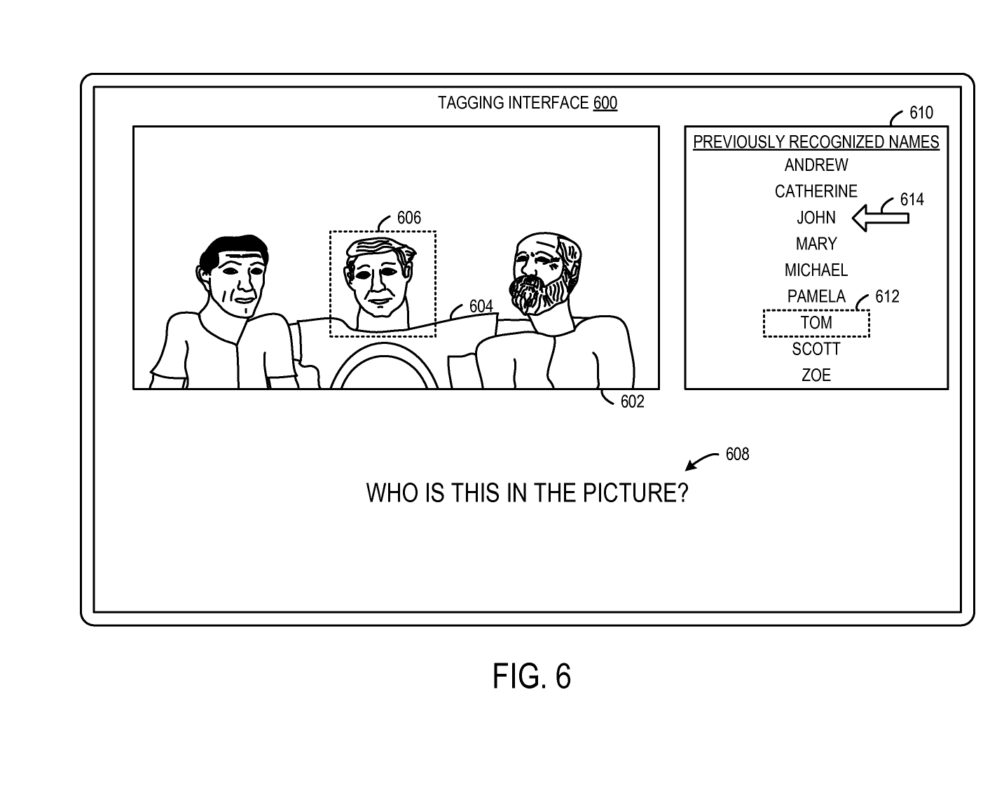

FIG. 6 schematically shows a tagging interface 600 for tagging a human subject in an image. For example, the tagging interface may be generated by the client application 204 shown in FIG. 2. The image 602 includes the human subject 604 recognized as being positioned at a dwell location of a tagging user's gaze via visual feedback 606 in the form of a box surrounding a head of the human subject 604. In response to the human subject 604 being recognized, a tag prompt 608 may be displayed in the tagging interface 600 that prompts the tagging user to provide or select an identification of the human subject.

In some embodiments, in response to the tag prompt 608 being displayed, the voice recognition service may be signaled to listen for a name being spoken by the tagging user via the microphone. If the voice recognition service detects a name, then the image may be tagged with the name.

In some embodiments, a set of previously recognized names 610 may be displayed in the tagging interface 600 to aid a user in providing or selecting an identification of the human subject 604. In some embodiments, a name 612 of the set of previously recognized names 610 may be selected as the identification of the human subject when the name 612 is recognized as being positioned at a dwell location of the tagging user's gaze on the display screen (e.g., the user's gaze may remain at the location of the name for greater than a first threshold duration). In other words, after the tagging user is prompted to provide an identification of the human subject, the tagging user merely looks at the name long enough to establish a dwell location signal in order to select the name.

In some embodiments, visual feedback may be provided in response to recognizing that the name 612 is located at the dwell location of the user's gaze. For example, the visual feedback may include highlighting the name, displaying a box around the name, displaying a cursor or other indicator pointing at the name, bolding the name, or otherwise modifying the name, etc. Once the visual feedback has been provided, the name may be selected as identification of the human subject in response to the gaze remaining on the name for a second threshold duration. The second threshold duration may start after the first threshold duration has concluded. For example, the second threshold duration may begin when the visual feedback that the name is recognized is provided.

The above described approach allows for the recognition of a human subject in an image and tagging of the image with the identification of the human subject to be done with only gaze detection and without any speaking or use of a mouse and/or keyboard. Moreover, the approach may be employed to tag a plurality of images only using gaze detection.

It is to be understood that, in some cases, the set of previously recognized names 610 need not include all previously recognized names, but may be a subset with only the closest guesses based on facial recognition or the like. In other cases, the set of previously recognized names may include all names that have been previously recognized. Furthermore, it is to be understood that the set of previously recognized names 610 may be displayed regardless of whether the tagging user provides an identification of the human subject via voice command or by gazing at a name in the set of previously recognized names.

Furthermore, in some embodiments, if a new name 614 is received as the identification of the human subject that is not included in the set of previously recognized names 610, the new name 614 may be added to the set of previously recognized names for future image tagging operations.

In some embodiments, when an image is tagged with an identification of a human subject, the identification may be associated with the entire image. In some embodiments, when an image is tagged with an identification of a human subject, the identification may be associated with a portion of the image that includes the human subject. For example, in the illustrated embodiment, the identification of the human subject 604 may be associated with the portion of the image contained by the visual feedback 606 (or the portion of the image occupied by the human subject). Accordingly, an image including a plurality of human subjects may be tagged with different identifications for each of the plurality of human subjects, and the different identifications may be associated with different portions of the image.

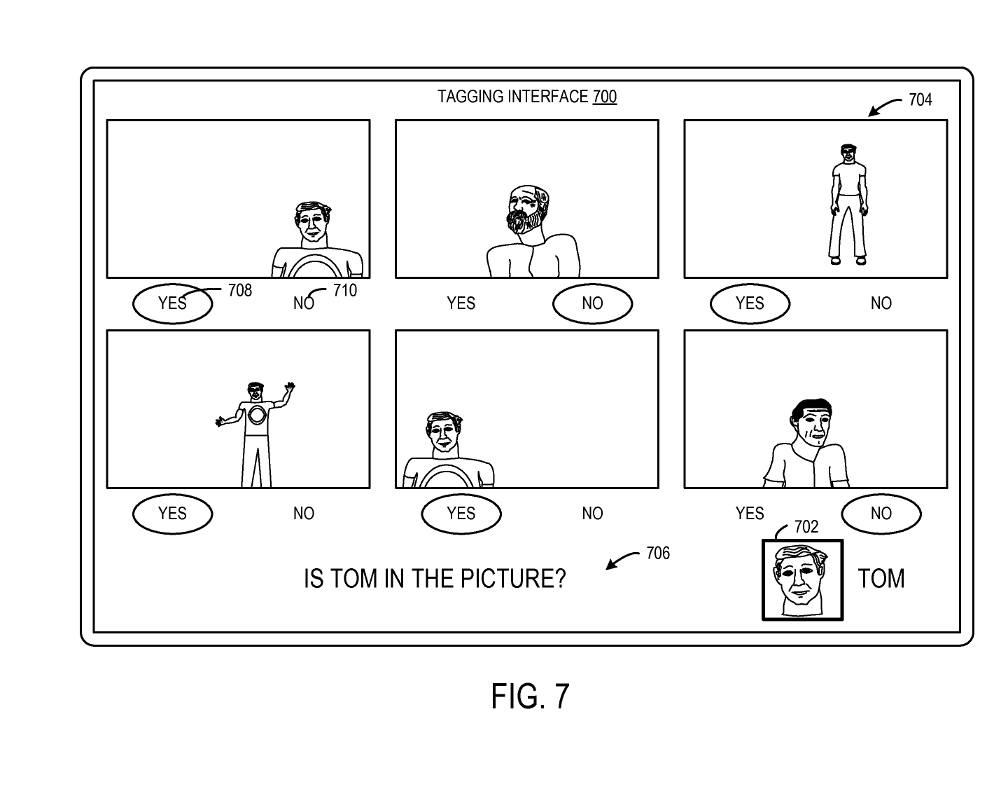

FIG. 7 schematically shows a tagging interface 700 for tagging a recognized human subject in different images. For example, the tagging interface 700 may be displayed on the display screen once a human subject has been recognized in an image, such as in tagging interface 600 shown in FIG. 6, and a facial pattern recognition algorithm has been run to identify images that potentially include the facial pattern of the human subject. The tagging interface 700 may include an instance of the recognized human subject 702 (e.g., extracted from the original image). The tagging interface 700 may include a plurality of images 704 that potentially include the recognized human subject 702. A confirmation prompt 706 may be displayed in the tagging interface 700 to prompt the tagging user to confirm whether a human subject in each of the plurality of images matches the recognized human subject 702.

In some embodiments, the tagging user may provide confirmation by establishing a dwell location on an image and providing a vocal confirmation, such as by saying “YES.” If a vocal confirmation is received, then the image may be tagged with the identification of the recognized human subject. On the other hand, the tagging user may say “NO” if the image does not include the recognized human subject. Alternatively or additionally, the tagging user may provide a name of the person in the image, and the image may be tagged with the name.

In some embodiments, the tagging user may provide confirmation by establishing a dwell location on a confirmation indicator (e.g., “YES”) 708 of an image. If a visual confirmation is received, then the image may be tagged with the identification of the recognized human subject. On the other hand, the tagging user may establish a dwell location on a denial indicator (e.g., “NO”) 710 if the image does not include the recognized human subject. Each image may have corresponding confirmation and denial indicators so that the plurality of images may be visually tagged in a quick manner.

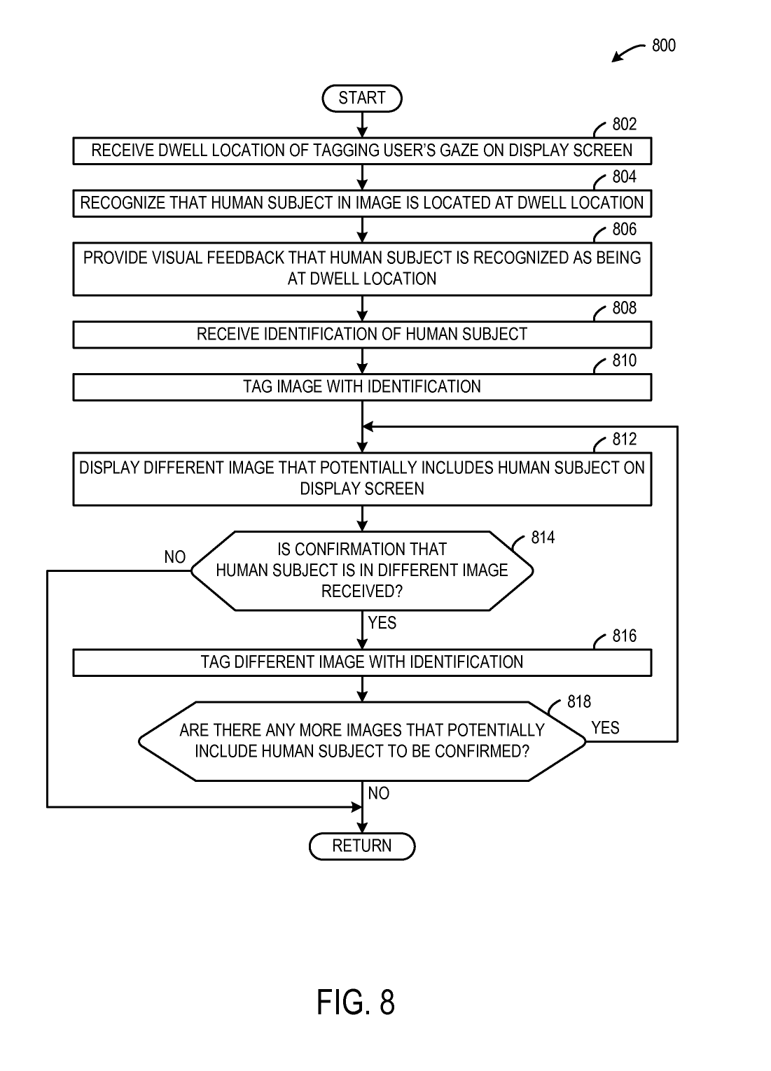

FIG. 8 shows a method 800 for tagging a human subject in an image presented on a display screen according to an embodiment of the present disclosure. For example, the method 800 may be performed by the computing system 100 shown in FIG. 1, and more particularly, the computer architecture 200 shown in FIG. 2

At 802, the method 800 may include receiving a dwell location of a tagging user's gaze on a display screen.

At 804, the method 800 may include recognizing that a human subject in an image displayed on the display screen is located at the dwell location.

At 806, the method 800 may include providing visual feedback that the human subject is recognized as being at the dwell location.

At 808, the method 800 may include receiving an identification of the human subject. For example, the identification may include a name of the human subject. However, it is to be understood that the identification may include any suitable description or characterization.

At 810, the method 800 may include tagging the image with the identification. In some embodiments, the identification may be associated with the entire image. In some embodiments, the identification may be associated with a portion of the image that just corresponds to the human subject.

At 812, the method 800 may include displaying a different image that potentially includes the human subject on the display screen.

At 814, the method 800 may include determining whether confirmation that the different image includes the human subject is received. If a confirmation that the human subject is in the different image is received, then the method 800 moves to 816. Otherwise, the method 800 returns to other operations.

At 816, the method 800 may include tagging the different image with the identification.

At 818, the method 800 may include determining whether there are any more images that potentially include the human subject to be confirmed and/or tagged with the identification. If there are more images that potentially include the human subject to be confirmed, then the method 800 returns to 812. Otherwise, the method 800 returns to other operations.

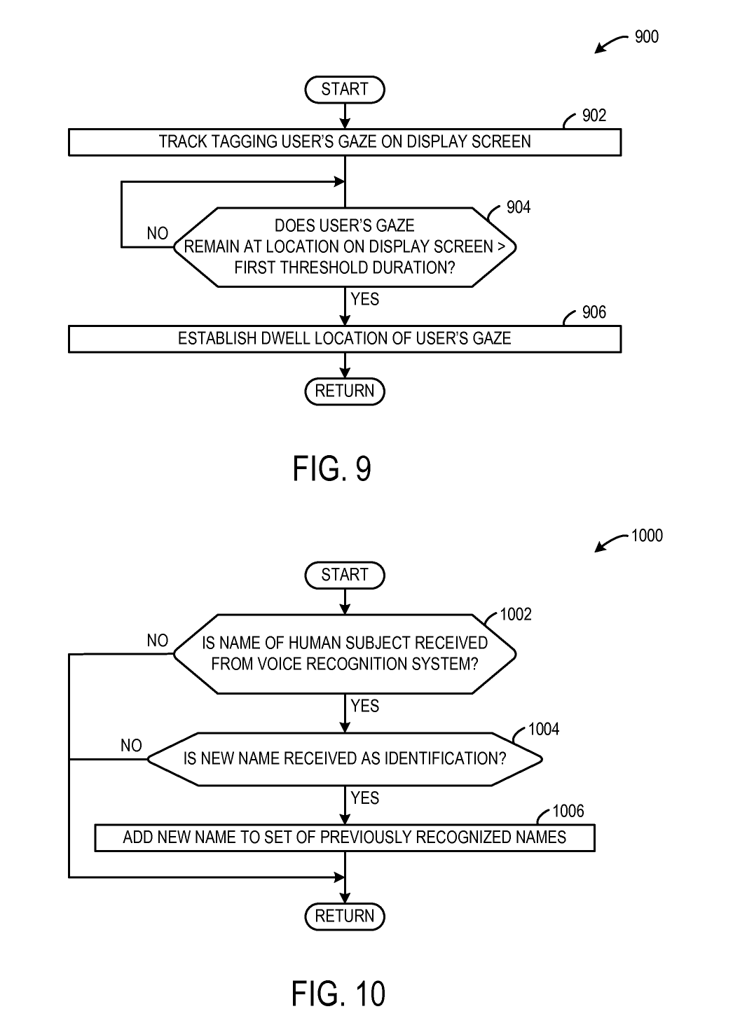

FIG. 9 shows a method 900 for establishing a dwell location of a tagging user's gaze according to an embodiment of the present disclosure. For example, the method 900 may be performed by the computing system 100 shown in FIG. 1, and more particularly, the computer architecture 200 shown in FIG. 2. For example, the method 900 may be performed to provide a dwell location for step 802 of the method 800 shown in FIG. 8.

At 902, the method 900 may include tracking a tagging user's gaze on a display screen. For example, the tagging user's gaze may be tracked by the eye tracking camera 108 shown in FIGS. 1 and 2.

At 904, the method 900 may include determining whether the tagging user's gaze remains at a location on the display screen for greater than a first threshold duration (e.g., 100 microseconds). If it is determined that the tagging user's gaze remains at the location on the display screen for greater than the first threshold duration, then the method 900 moves to 906. Otherwise, the method 900 returns to 904.

At 906, the method 900 may include establishing the dwell location at the location on the display screen where the tagging user's gaze remained for greater than the first threshold duration. In one example, the dwell location may be established by the eye tracking service 202 and sent to the client application 204.

FIG. 10 shows a method 1000 for recognizing identification of a human subject according to an embodiment of the present disclosure. For example, the method 1000 may be performed by the computing system 100 shown in FIG. 1, and more particularly, the computer architecture 200 shown in FIG. 2. For example, the method 1000 may be performed to provide an identification of a human subject for step 808 of the method 800 shown in FIG. 8, among other method steps.

At 1002, the method 1000 may include determining whether a name of a human subject is received from a voice recognition system that listens for a name being spoken. If a name is received from the voice recognition system, then the method 1000 moves to 1004. Otherwise, the method 1000 returns to other operations.

At 1004, the method 1000 may include determining whether the name received as identification of the human subject is a new name or a previously recognized name. If a new name that is not included in set of previously recognized names is received, then the method 1000 moves to 1006. Otherwise, the method 1000 returns to other operations.

At 1006, the method 1000 may include adding the new name to a set of previously recognized names.

The above described method may be performed using a voice recognition system to receive a name as identification of a human subject recognized via detection of a tagging user's gaze.

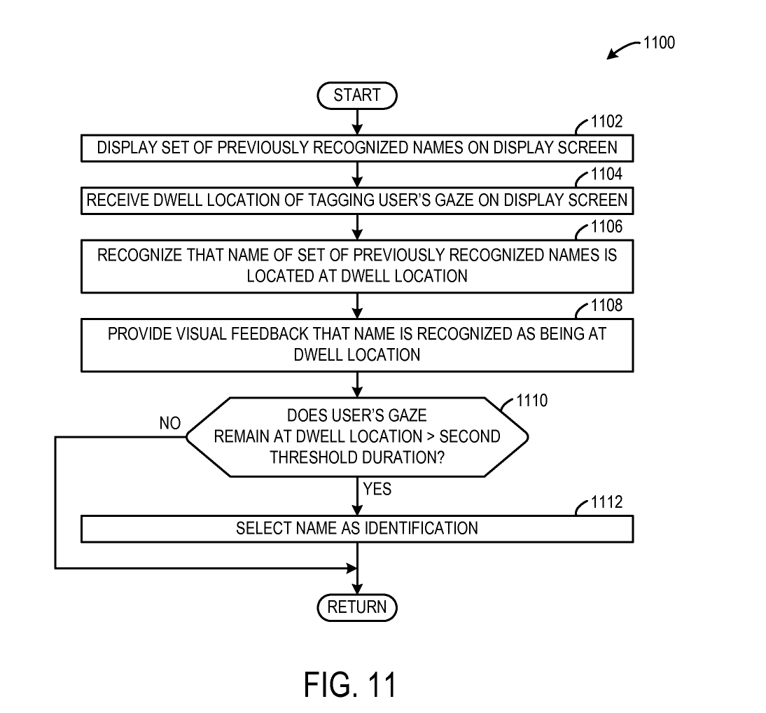

FIG. 11 shows a method 1100 for recognizing identification of a human subject according to another embodiment of the present disclosure. For example, the method 1100 may be performed by the computing system 100 shown in FIG. 1, and more particularly, the computer architecture 200 shown in FIG. 2. For example, the method 1100 may be performed to provide an identification of a human subject for step 808 of the method 800 shown in FIG. 8, among other method steps.

At 1102, the method 1100 may include displaying a set of previously recognized names on the display screen. In some embodiments, the set of previously recognized names may be displayed on the display screen in response to the human subject being recognized as being located at a dwell location of the tagging user's gaze.

At 1104, the method 1100 may include receiving a dwell location of the tagging user's gaze on the display screen.

At 1106, the method 1100 may include recognizing that a name from the set of previously recognized names is located at the dwell location. For example, the user's gaze may remain at the location of the name on the display screen for greater than a first threshold duration (e.g., 100 microseconds).

At 1108, the method 1100 may include providing visual feedback that the name is recognized as being at the dwell location. For example, a cursor or other indicator may point to the name or the name may be bolded, highlighted, or otherwise modified to indicate the visual feedback.

At 1110, the method 1100 may include determining whether the user's gaze remain at the dwell location for greater than a second threshold duration (e.g., 100 microseconds. The second threshold duration may begin once the first threshold duration has concluded, such as when the visual feedback that the name is recognized is provided. The second threshold duration may be employed to aid the user in making an accurate selection. If the user's gaze remains at the dwell location for greater than the second threshold duration, then the method 1100 moves to 1112. Otherwise, the method 1100 returns to other operations.

At 1112, the method 1100 may include selecting the name as the identification in response to recognizing that the name is located at the dwell location.

The above described method may be performed to select a name as an identification of a human subject only using gaze detection. It is to be understood that such an approach may be performed while the user is silent and still (e.g., no mouth, head, or hand motion).

The above described methods may be performed to tag images in a manner that is quicker and less labor intensive then a tagging approach that uses a keyboard and mouse. It is to be understood that the methods may be performed at any suitable time. For example, the methods may be performed while taking a photograph, or just after taking a photograph, such tagging may be performed using a camera or mobile device. As another example, the tagging methods may be performed as a post processing operation, such as on a desktop or tablet computer. Moreover, it is to be understood that such methods may be incorporated into any suitable application including image management software, social networking applications, web browsers, etc.

While the tagging approach has been discussed in the particular context of recognizing a human subject and providing a name as identification of the human subject, it is to be understood that such concepts are broadly applicable to recognizing any suitable object and providing any suitable identification of that object.

In some embodiments, the methods and processes described herein may be tied to a computing system of one or more computing devices. In particular, such methods and processes may be implemented as a computer-application program or service, an application-programming interface (API), a library, and/or other computer-program product.

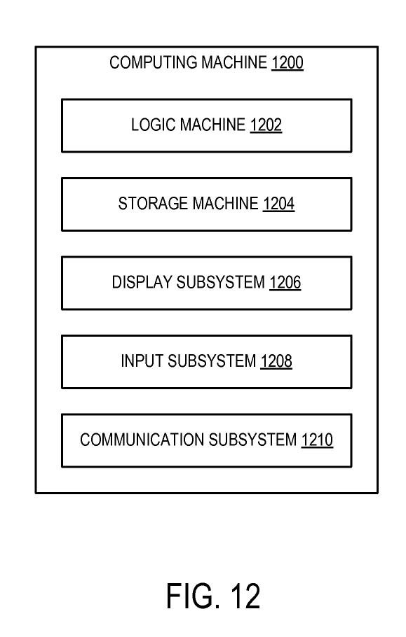

FIG. 12 schematically shows a non-limiting embodiment of a computing system 1200 that can enact one or more of the methods and processes described above. Computing system 1200 is shown in simplified form. Computing system 1200 may take the form of one or more personal computers, server computers, tablet computers, home-entertainment computers, network computing devices, gaming devices, mobile computing devices, mobile communication devices (e.g., smart phone), and/or other computing devices. For example, computing system 1200 may be representative of any or all of the computing devices in the computing system 100 shown in FIG. 1. Further, the computing system 1200 may be configured to implement the computer architecture 200 shown in FIG. 2.

Computing system 1200 includes a logic machine 1202 and a storage machine 1204. Computing system 1200 may optionally include a display subsystem 1206, input subsystem 1208, communication subsystem 1210, and/or other components not shown in FIG. 12.

Logic machine 1202 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1204 includes one or more physical devices configured to hold instructions executable by the logic machine to implement the methods and processes described herein. When such methods and processes are implemented, the state of storage machine 1204 may be transformed—e.g., to hold different data.

Storage machine 1204 may include removable and/or built-in devices. Storage machine 1204 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1204 may include volatile, nonvolatile, dynamic, static, read/write, read-only, random-access, sequential-access, location-addressable, file-addressable, and/or content-addressable devices.

It will be appreciated that storage machine 1204 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1202 and storage machine 1204 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1200 implemented to perform a particular function. In some cases, a module, program, or engine may be instantiated via logic machine 1202 executing instructions held by storage machine 1204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1206 may be used to present a visual representation of data held by storage machine 1204. This visual representation may take the form of a graphical user interface (GUI). As the herein described methods and processes change the data held by the storage machine, and thus transform the state of the storage machine, the state of display subsystem 1206 may likewise be transformed to visually represent changes in the underlying data. Display subsystem 1206 may include one or more display devices utilizing virtually any type of technology. Such display devices may be combined with logic machine 1202 and/or storage machine 1204 in a shared enclosure, or such display devices may be peripheral display devices.

When included, input subsystem 1208 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1210 may be configured to communicatively couple computing system 1200 with one or more other computing devices. Communication subsystem 1210 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for tagging a human subject in an image presented on a display screen, the method comprising:
receiving a dwell location of a tagging user's gaze on the display screen;
recognizing that the human subject in the image is located at the dwell location;
receiving an identification of the human subject; and
tagging the image with the identification.

2. The method of claim 1, wherein receiving the identification of the human subject includes receiving a name of the human subject from a voice recognition system that listens for the name being spoken.

3. The method of claim 1, wherein receiving the identification of the human subject includes displaying a set of previously recognized names on the display screen, receiving a different dwell location of the tagging user's gaze on the display screen, recognizing that a name from the set of previously recognized names is located at the different dwell location, and selecting the name as the identification.

4. The method of claim 1, wherein receiving the dwell location includes tracking the tagging user's gaze on the display screen, and establishing the dwell location responsive to the tagging user's gaze remaining at a location on the display screen corresponding to the dwell location for greater than a threshold duration.

5. The method of claim 1, further comprising:
providing visual feedback that the human subject is recognized as being at the dwell location.

6. The method of claim 5, wherein providing visual feedback includes at least one of displaying a box surrounding a head of the human subject, graying out the image surrounding the head of the human subject, and enlarging the head of the human subject relative to a remainder of the image.

7. The method of claim 1, further comprising:
displaying a different image that potentially includes the human subject on the display screen; and
if a confirmation that the human subject is in the different image is received, tagging the different image with the identification.

8. The method of claim 1, further comprising:
displaying a set of previously recognized names on the display screen in response to the human subject being recognized as being located at the dwell location; and
if a new name is received as the identification of the human subject that is not included in the set of previously recognized names, adding the new name to the set of previously recognized names.

9. The method of claim 1, wherein tagging the image with the identification includes associating the identification with a portion of the image that includes the human subject.

10. A method for tagging a human subject in an image presented on a display screen, the method comprising:
receiving a dwell location of a tagging user's gaze on the display screen;
recognizing that the human subject in the image is located at the dwell location;
receiving a name of the human subject from a voice recognition system that listens for the name being spoken; and
tagging the image that includes the human subject with the name.

11. The method of claim 10, wherein receiving the dwell location includes tracking the tagging user's gaze on the display screen, and establishing the dwell location responsive to the tagging user's gaze remaining at a location on the display screen corresponding to the dwell location for greater than a threshold duration.

12. The method of claim 10, further comprising:
providing visual feedback that the human subject is recognized as being at the dwell location.

13. The method of claim 12, wherein providing visual feedback includes at least one of displaying a box surrounding a head of the human subject, graying out the image surrounding the head of the human subject, and enlarging the head of the human subject relative to a remainder of the image.

14. The method of claim 10, further comprising:
displaying a different image that potentially includes the human subject on the display screen; and
if a confirmation that the human subject is in the different image is received, tagging the human subject in the different image with the name.

15. The method of claim 10, further comprising:
displaying a set of previously recognized names on the display screen in response to the human subject being recognized as being located at the dwell location; and
if a new name is received as an identification of the human subject that is not included in the set of previously recognized names, adding the new name to the set of previously recognized names.

16. The method of claim 10, wherein tagging the image with the name includes associating the name with a portion of the image that includes the human subject.

17. A method for tagging a human subject in an image presented on a display screen, the method comprising:
tracking a tagging user's gaze on the display screen;
establishing a dwell location responsive to the tagging user's gaze remaining at a location on the display screen corresponding to the dwell location for greater than a threshold duration;
recognizing that the human subject in the image is located at the dwell location;
receiving a name of the human subject from a voice recognition system that listens for the name being spoken; and
tagging a portion of the image that includes the human subject with the name.

18. The method of claim 17, further comprising:
providing visual feedback that the human subject is recognized as being at the dwell location including at least one of displaying a box surrounding a head of the human subject, graying out the image surrounding the head of the human subject, and enlarging the head of the human subject relative to a remainder of the image.

19. The method of claim 17, further comprising:
displaying a different image that potentially includes the human subject on the display screen; and
if a confirmation that the human subject is in the different image is received, tagging the human subject in the different image with the name.

20. The method of claim 17, further comprising:
displaying a set of previously recognized names on the display screen in response to the human subject being recognized as being located at the dwell location; and
if a new name is received as an identification of the human subject that is not included in the set of previously recognized names, adding the new name to the set of previously recognized names.
